(19) United States
(12) Patent Application Publication
(10) Pub. No.: US 2013/0342577 A1
(43) Pub. Date: Dec. 26, 2013

(54) IMAGE SYNTHESIS FOR DIAGNOSTIC REVIEW

(71) Applicant: Carestream Health, Inc., Rochester, NY (US)

(72) Inventors: Xiaohui Wang, Pittsford, NY (US); William J. Sehnert, Fairport, NY (US); Carl R. Wesolowski, Rochester, NY (US)

(21) Appl. No.: 13/922,515

(22) Filed: Jun. 20, 2013

Related U.S. Application Data
(60) Provisional application No. 61/662,029, filed on Jun. 20, 2012.

(51) Int. Cl. G06T 11/60

(52) U.S. Cl. CPC G06T 11/60
USPC 345/634

(57) ABSTRACT

Embodiments of methods and/or apparatus can allow a viewing practitioner to adjust how image content can combined from multiple radiographic images of the same subject or different image processing of one image of a subject to control additional information gained by the combination and/or for improved diagnosis. In one embodiment, a method for displaying radiographic image content is executed at least in part by a computer and can include obtaining image data for a first radiographic image of a patient; obtaining image data for a second radiographic image of a patient; combining the image data from the first and second images and displaying the result as a combined radiographic image; recombining the image data from the first and second images according to a viewer instruction that conditions how the first and second images are recombined and re-displaying the result as the combined radiographic image.

### REFERENCE TO RELATED APPLICATIONS

This application claims the benefit of U.S. Provisional Patent Application Ser. No. 61/662,029 filed Jun. 20, 2012 in the names of Xiaohui Wang et al., titled IMAGE BLENDING FOR DIAGNOSTIC REVIEW, the contents of which are incorporated fully herein by reference.

### FIELD OF THE INVENTION

The invention relates generally to the field of medical imaging and more particularly relates to apparatus and methods for combining and displaying images using information from radiographic images of the same patient obtained or processed under different conditions.

### BACKGROUND OF THE INVENTION

Radiographic imaging is a powerful tool for obtaining vital information related to a patient and can provide a considerable amount of information on internal features, including structures, devices, organs, and tissues. In order to provide the most useful information for a particular purpose, the radiographic image is obtained under exposure conditions that are selected or optimized for that purpose by the radiographic technician. In conventional practice, various kVp (kilovolt-peak) settings are used at different times, depending on factors such as the anatomy of interest and relative patient size, for example.

In addition to parameters used to control exposure conditions, the same raw radiographic image data can be processed in a number of ways. Different processing methods and parameter settings are used to process or optimize the processed image data for its particular diagnostic function. Characteristics of the image that affect presentation of the image data, such as contrast, brightness, spatial filtering, and the like are pre-adjusted in various ways by the radiographic technician so that the image is in the form preferred by the practitioner and/or useful for a particular purpose.

A number of methods have been developed for combining image content taken under different exposure conditions or processed in different ways. Dual-energy imaging is one type of method that has been used to obtain additional information from different exposures, such as bone density for osteoporosis studies, for example. Dual-energy images can be obtained by using two exposures of relatively high and low energy levels in close succession, or can be obtained using multiple detectors with different x-ray beam filtering for the same exposure. Thus, radiation energy levels can be changed, for example, by changing the radiation beam energy (e.g., kVp levels), or filters though which the radiation beam passes. The dual-energy image is formed by combining image data from each of the separate exposures, weighting or otherwise adjusting the combined values in order to obtain additional information that would be difficult to extract from either the low energy or high energy image content by itself. Various types of combination algorithms are used to provide a single dual-energy image that is usable by the medical practitioner. See for example, U.S. Pat. No. 6,016,356 (Ito et al.) that describes performing frequency processing and the superposition of several images.

Other types of image processing operate by processing image data from the same exposure in different ways, then combining the processed results. Various types of spatial filtering, for example, can be applied to form intermediate images that are then combined to help separate signal content from noise content.

Conventionally, the viewing practitioner (e.g., radiologist) views only the processed image results and does not provide any input on how individual images are combined and presented. Once the radiographic technician's expectations (then ultimately diagnosing practitioners) for standard image presentation of a dual-energy or other image are met by the radiographic technician, the same parameters for exposure, processing, and combination (e.g., prefixed bone and soft tissue images) are used by the radiographic technician for any further images of the same type processed by the imaging system. No adjustments are provided for the viewer and/or viewing practitioner.

### SUMMARY OF THE INVENTION

An aspect of this application is to advance the art of medical digital radiography.

Another aspect of this application to address in whole or in part, at least the foregoing and other deficiencies in the related art.

It is another aspect of this application to provide in whole or in part, at least the advantages described herein.

An object of the present invention is to address the need for providing enhanced control over radiographic image presentation to the viewing practitioner (e.g., radiologist). In particular, embodiments of the present invention are directed to applications that combine multiple images of the same patient anatomy in selected ways and/or interactively to provide enhanced image content.

These objects are given only by way of illustrative example, and such objects may be exemplary of one or more embodiments of the invention. Other desirable objectives and advantages inherently achieved by the disclosed invention may occur or become apparent to those skilled in the art. The invention is defined by the appended claims.

According to one aspect of the invention, there is provided a method for displaying radiographic image content, the method can include obtaining image data for a first radiographic image of a patient; obtaining image data for a second radiographic image of a patient; combining the image data from the first and second images and displaying the result as a combined radiographic image; recombining the image data from the first and second images according to a viewer instruction that conditions how the first and second images are combined and re-displaying the result as the combined radiographic image. In one embodiment, the recombining can result in viewer defined or generated companion images for the first, second and/or combined radiographic images. In one embodiment, the recombining can be between a plurality of preset image treatments configured to display or highlight a specific material in the display (image) to allow a viewer to access/view/emphasize different materials (or material combinations) comprising a subject. In one embodiment, the recombining can include a secondary viewable component corresponding to a confidence or certainty value (e.g., transparency) in material identification in the image/displayed image.

### BRIEF DESCRIPTION OF THE DRAWINGS

The foregoing and other objects, features, and advantages of the invention will be apparent from the following more particular description of the embodiments of the invention, as illustrated in the accompanying drawings. The elements of the drawings are not necessarily to scale relative to each other.

FIG. 1 is a logic flow diagram that shows a basic image processing sequence for acquired radiographic image data.

FIG. 2 is a logic flow diagram that shows a basic imaging processing sequence for dual-energy imaging.

FIG. 3 is a logic flow diagram showing the sequence of steps used for forming a combined image from two other primary or secondary images of the same patient anatomy.

FIG. 4 is a schematic block diagram that shows a system embodiment for medical image procurement and management according to an embodiment of the application.

FIG. 5 is a logic flow diagram that shows how blending can be employed according to an embodiment of the application.

FIG. 6 is a diagram that shows a plan view of an operator interface used for blending images according to an embodiment of the application.

FIGS. 7A-7B are diagrams that show plan views of a viewer display console that allows entry of exemplary viewer instructions to adjust end-user image synthesis according to an embodiment of the application.

FIG. 8 is a logic flow diagram that shows a synthesis process according to an embodiment of the application.

FIGS. 9A-9C is are diagrams that show plan views of an operator interface used for combining images according to embodiments of the application.

### DESCRIPTION OF EXEMPLARY EMBODIMENTS

The following is a detailed description of the embodiments of the application, reference being made to the drawings in which the same reference numerals identify the same elements of structure in each of the several figures.

The subject matter of the present invention relates to digital image processing, which is understood to mean technologies that digitally process a digital image to recognize and thereby assign useful meaning to human understandable objects, attributes or conditions, and then to utilize the results obtained in the further processing of the digital image.

Where they are used, the terms “first”, “second”, and so on, do not necessarily denote any ordinal, sequential, or priority relation, but are simply used to more clearly distinguish one element or set of elements from another, unless specified otherwise. The term “pixel” has its standard meaning, referring to a picture element, expressed as a unit of image data.

In the context of the present disclosure, the terms “viewer”, “operator”, and “user” are considered to be equivalent and refer to the viewing practitioner (e.g., radiologist) or other person who reviews and manipulates an x-ray image, such as an image derived from dual-energy exposures, on a display monitor (e.g., for diagnosis) away from the x-ray image acquisition apparatus. A “viewer instruction” can be obtained from explicit commands entered by the viewer, such as entered on a keyboard or entered using a computer mouse or similar device, or may be implicitly obtained or derived based on some other user action.

The increasing acceptance and use of digital radiographic imaging and image processing has made practitioners more aware of the potential for extracting information based on treatment of the image data. When images such as dual-energy images are combined, standard image treatments may work well in a large number of cases; however, there can be situations where features are less visible with conventional combination techniques. Exemplary embodiments of methods and/or apparatus described herein can allow the viewing practitioner to exert a measure of control over how images are combined, which can operate to provide additional information. Embodiments of methods and/or apparatus can allow the viewing practitioner to interactively adjust how image content is combined from multiple images of the same patient anatomy. Embodiments of methods and/or apparatus can allow the viewing practitioner to adjust how image content is combined from multiple images of the same patient anatomy to control additional information gained by the combination and/or for improved diagnosis.

For the description that follows, the terms “primary” and “secondary” image data relate to the amount of image processing that has been provided to image data. Raw image data, such as from a digital detector or digitizing apparatus, is considered to be primary image data. Generally, raw image data can be calibrated (e.g., processed for gain, offset and/or defect correction) and still be considered primary image data. Processed image data is then considered to be secondary image data.

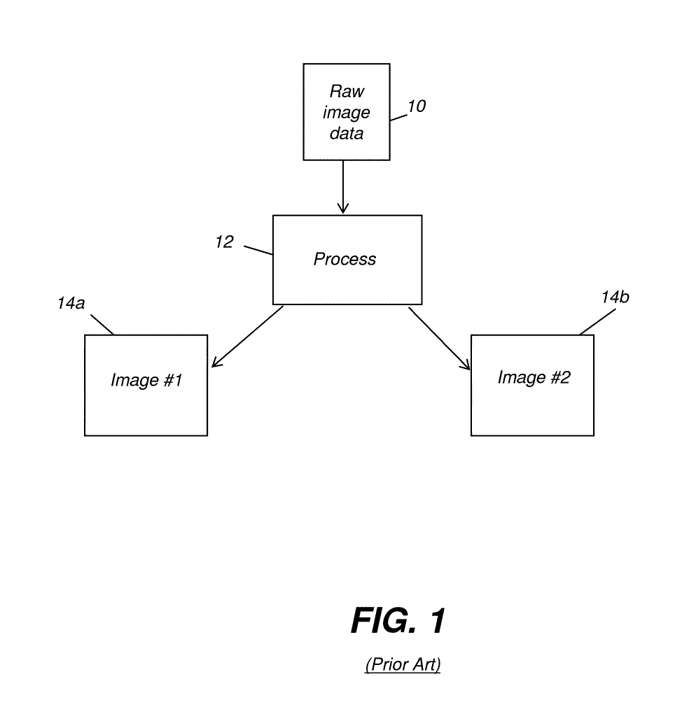

In order to better understand aspects of the application, it is useful to review how radiographic images are processed in various applications. The logic flow diagram of FIG. 1 shows a basic image processing sequence for acquired radiographic image data, such as data from a single x-ray exposure. Raw image data 10 is directed to an image processor 12 that is programmed to provide one or more processed images, represented by processed images 14a and 14b in FIG. 1. As is well known to those skilled in the imaging arts, any number of processed images could be generated from the same raw image data 10 using various types of spatial filters and algorithmic methods for enhancing or suppressing various image characteristics, such as contrast, brightness, tone scale, edge transitions, and the like. Following this processing by processor 12, the same input raw image data 10 can be enhanced and presented in different ways, depending on the parameters and tools used.

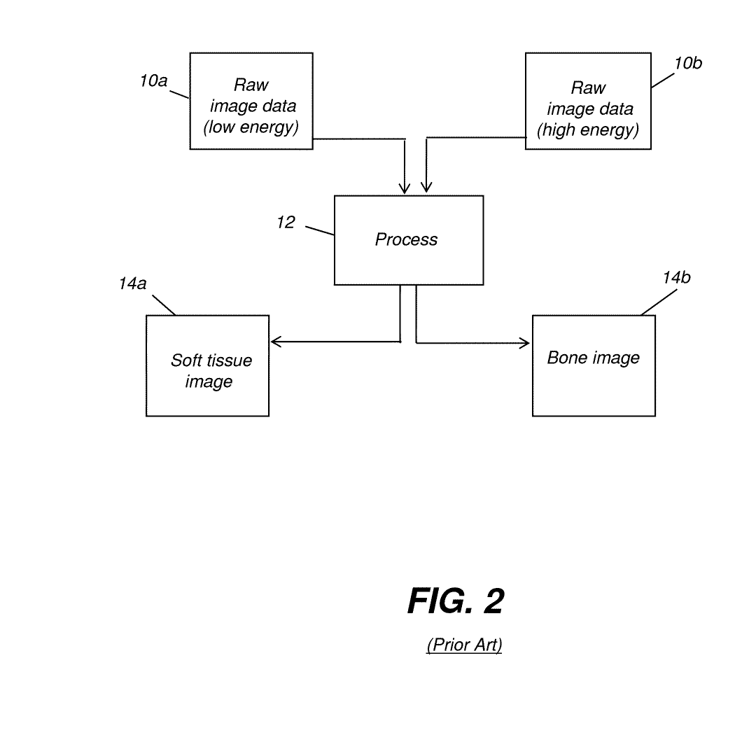

Some types of radiographic image processing combine primary image data from more than one exposure. The logic flow diagram of FIG. 2 shows a basic imaging processing sequence for dual-energy imaging. A first (e.g., low energy exposure) can generate raw image data 10a. A second (e.g., high energy exposure) can generate raw image data 10b.

Processor 12 takes both of these forms of primary data and generates secondary images for soft tissue and bone, shown as images 14a and 14b, respectively in FIG. 2. See for example, U.S. Pat. No. 6,917,697(B2), U.S. Pat. No. 6,792,072(B2), U.S. Pat. No. 6,614,874(B2, U.S. Pat. No. 6,343,111(B1), or U.S. Pat. No. 7,068,826(B2) that variously describe/teach known ways to calculate the bone and soft tissue subtraction parameters, respectively, for exemplary bone and soft tissue images.

Soft tissue image 14a and bone image 14b are different types of secondary images, generated by processing data from two or more primary images. Thus, primary image data values from both the low energy image data 10a and high energy image data 10b are combined to generate soft tissue image 14a as a secondary image. Similarly, image data values from both the low energy image data 10a and high energy image data 10b are combined to generate bone image 14b.

Embodiments of the present invention obtain radiographic image data for first and second images of a patient, then combine the first and second images to display the result as a secondary radiographic image. Certain exemplary embodiments allow the radiologist to interactively and/or iteratively control the combination of the first and second images that results in a selected/desired secondary image. In one embodiment, the first and second images/image data can be assigned/displayed as different colors, instead of grayscale. In another embodiment, the first and second images can be primary images/image data, secondary images/image data or a combination thereof. It is instructive to consider a number of ways in which different first and second images of the same patient anatomy are obtained and to describe a number of approaches to their combination to provide a combined radiographic image.

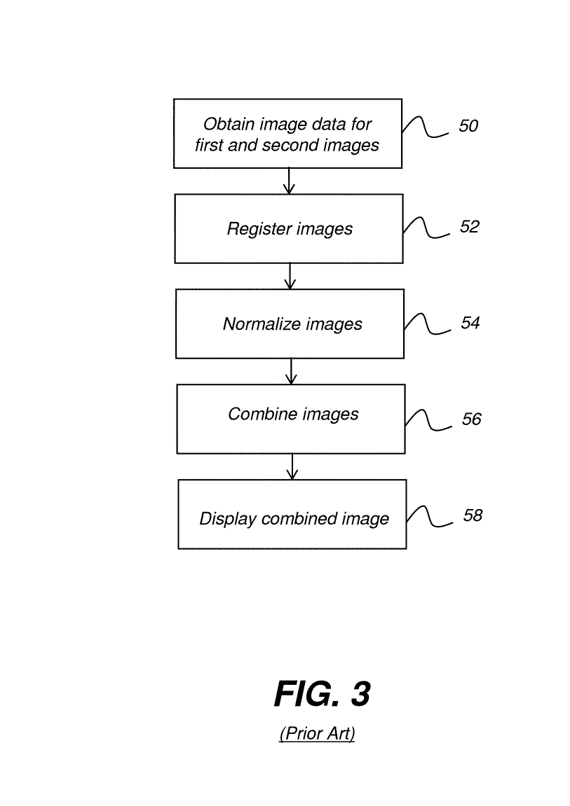

The logic flow diagram of FIG. 3 shows a sequence of steps that can be used for forming a combined image from two other primary or secondary images of the same patient anatomy. Image data are obtained or acquired in an obtain images step 50. Image data may be obtained, for example, from a digital detector or from data storage, such as from a DICOM compliant PACS. Registration and normalization steps 52 and 54, executed in any order, correlate the image data between the two images to be combined and/or standardize data presentation appropriately for the combination. Exemplary operations for registration are known to one skilled in the art, see for example, U.S. Pat. No. 8,180,124. Exemplary operations for nomalization are known to one skilled in the art, see for example, US Patent Publication 2008/0192898. A combination step 56 then combines the two images according to predetermined or technician-entered parameters, for example, as described herein entered at the radiographic image acquisition apparatus. The resultant combined image is then displayed in a display step 58. Optionally, the combined image is also stored.

Conventional solutions for image storage and retrieval and for association of multiple images obtained for the same patient can employ the PACS (Picture Archiving and Communication System) and various conventional database tools. Thus, as described herein, the PACS is an image store accessible to a radiographic imaging system or an agent thereof to retrieve images therefrom. Further, the PACS can implement the Digital Imaging and Communications in Medicine (DICOM) data interchange standard.

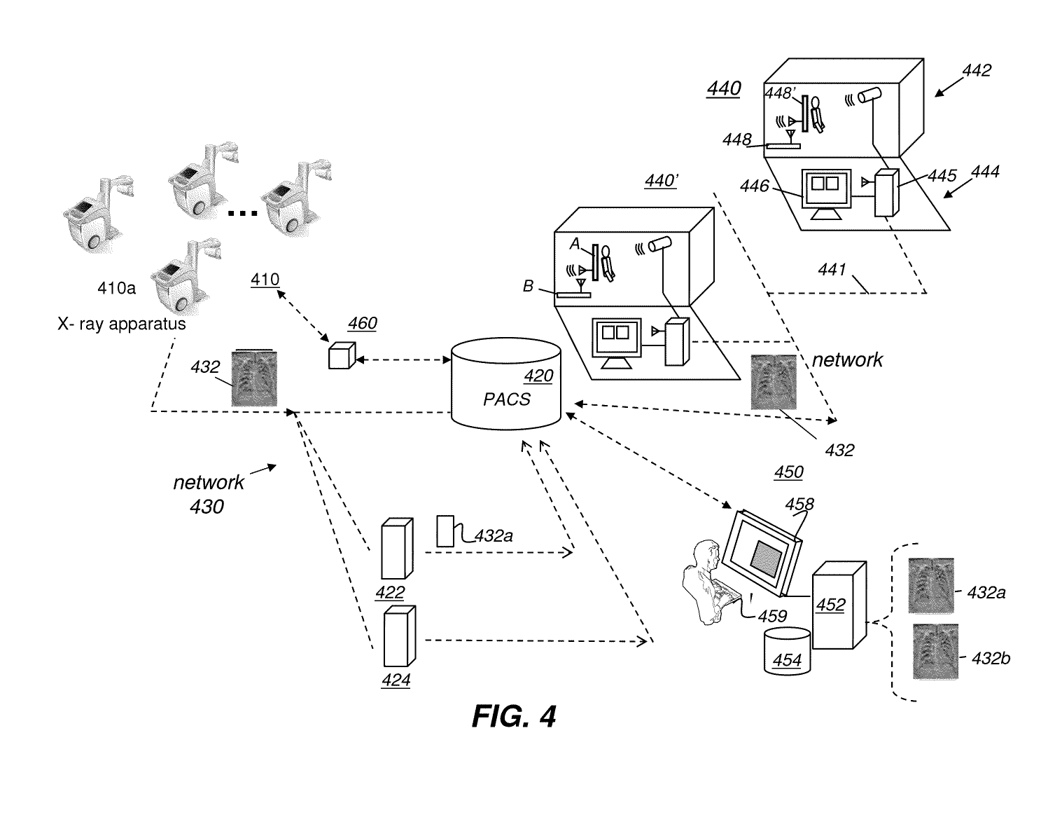

FIG. 4 is a schematic block diagram that shows an exemplary system embodiment for medical image procurement and management. FIG. 4 shows an exemplary relationship of acquisition digital radiographic imaging apparatus (e.g., mobile DR imaging apparatus 410, x-ray imaging room 440), reviewing radiographic imaging apparatus (e.g., workstation 450) and/or storage radiographic imaging apparatus (e.g., PACS 420).

As shown in FIG. 4, connected to a PACS 420 can be one or more X-ray imaging room 440 that can include an imaging room 442 (e.g., a shielded area in which a patient is imaged and containing an x-ray source), and a control room 444 that can include a display 446 and controller 445 for communicating with DR detectors 448 over a wireless interface and containing control logic for supporting and executing imaging operations with a selected DR detector 448′. In the embodiment shown, display 446 can be a touchscreen display, enabling the technician to easily control the X-ray imaging room 440 and select among several DR detectors 448 at least one active DR detector 448′ for obtaining the image using a graphical user interface (GUI). Imaging rooms 440 can be connected to the PACS 420 using a network 441 (e.g., wired, wireless, proprietary, public). Further, a communication network 430 can interconnect the PACS 420 with a mobile DR imaging apparatus 410 (directly, indirectly, via a server 460 or the like), a server 460, x-ray imaging rooms 440, 440′ and/or an image management system 450. The communication network 430 may be wired, wireless, proprietary, or public and comprised of many interconnected computer systems and communication links. Communication links may be hardwire links, optical links, satellite or other wireless communication links, wave propagation links, or any other mechanisms for communication of information. A mobile DR imaging apparatus 410 can communicate with its corresponding DR detectors (e.g., over a wireless interface) and include control logic for supporting and executing imaging operations with at least one selected DR detector among its corresponding DR detectors.

As noted previously, a first image 432 that can be obtained from an image capture by a DR imaging apparatus (e.g., mobile DR imaging apparatus 410a). In accordance with exemplary embodiments according to the application, first image 432 can be directly provided for storage in the PACS 420 either as raw (e.g., first image 10a, second image 10b) and/or processed image data (e.g., bone image 14a, soft tissue image 14b). Alternatively, the first image 432 can be stored at the DR imaging apparatus and provided indirectly or later to the PACS 420.

First image 432 can be provided to one or more logic processors 422, 424 that each can perform some type of image processing and analysis operation before a secondary images 432a can be stored in the PACS 420 along with acquired the first image 432. As shown in FIG. 4 the first image 432 can be pre-processed and suitable for storage/archival as it is provided from a DR imaging apparatus. It should be noted that, in an alternate embodiment, first image 432 may be provided as raw data, requiring some amount of processing prior to storage in PACS 420.

As shown in FIG. 4, an image management system 450 coupled to the system can include a logic processor 452, a memory 454, and an viewer console that can include a display 458 and an operator entry device 459, such as a keyboard, mouse, touch screen, or other device for entry of operator commands. Commands at image management system 450 provide an additional capability for retrieval, review and/or management of the images stored in the system (e.g., PACS). Logic processors (e.g., logic processors 452) can generate additional processed secondary images 432a from raw data or from pre-processed primary image 432, as shown in FIG. 4.

In one exemplary embodiment, a viewer can operate the image management system 450 to generate a selected (or displayed) radiographic secondary image that can be varied so that the viewer generated secondary radiographic image is predominantly a soft tissue image, predominantly a bone image, or somewhere between, influenced by both bone and soft tissue content or the like. Again, image data of a first image (e.g., soft tissue image) and image data of a second image (e.g., the bone image) used to generate a prescribed secondary image can be assigned different colors and displayed as different colors in the prescribed secondary image, which can be varied by the viewer.

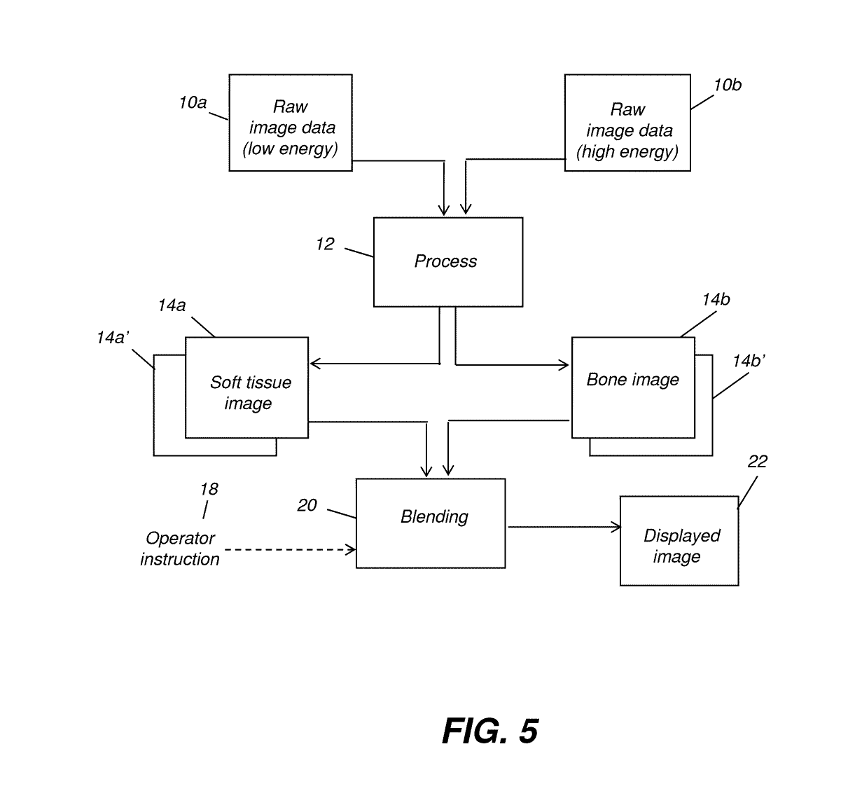

Embodiments according to the application can follow the general flow used for combining images that is shown in FIG. 3, but can allow the viewer to repeatedly modify how combination step 56 is performed (e.g., at image management system 450). A variable synthesis process allows the viewer to vary the content for an image that is formed and/or displayed by combining two or more other images. The logic flow diagram of FIG. 5 shows the position/timing of a synthesis (e.g., blending) process 20 for generating a displayed image 22 according to one exemplary embodiment of the application. As was shown previously with reference to FIG. 2, processing can be used to generate two pre-set images, a soft tissue image and a bone image, at the radiographic image acquisition apparatus. Further, additional pre-set secondary images can be generated at the image acquisition apparatus including a general radiation (gen rad) image (e.g., as a combination of the low energy and high energy imaging).

Synthesis process 20 performs the image combination to generate displayed image 22 when prompted by a viewer instruction 18. In the example of FIG. 5, displayed image 22 can be varied so that it is predominantly a soft tissue image, predominantly a bone image, or somewhere between, influenced by both bone and soft tissue content, or a summed/weighted image for improved SNR. In one exemplary embodiment, synthesis process 20 can operate linearly or nonlinearly. In another exemplary embodiment, synthesis processes 20 can operate according to one of the following equations:

R(x,y)=αL(x,y)+(1−α)H(x,y), (1)

where L is a first image data, H is second image data, and α is between −1 and +1.

R(x,y)=L(x,y)*cos α+H(x,y)*sin α, (2)

where L is a first image data, H is second image data, and α is an angle between 0°-360°.

In one embodiment, the first image data L and the second image data H can include primary image data or secondary image data.

In one embodiment, the processor 12 can further generate at least one selected radiographic secondary image (e.g., pre-set at the image acquisition apparatus) shown as secondary images 14a′ and/or secondary images 14b′ in FIG. 5.

In one embodiment, multi-resolution contrast enhancements and/or noise suppression can be applied the generation of the soft tissue image 14a and/or the bone image 14b. See for example, EP 0527525 that describes multi-resolution contrast enhancements and/or noise suppression of several images as known to one skilled in the art.

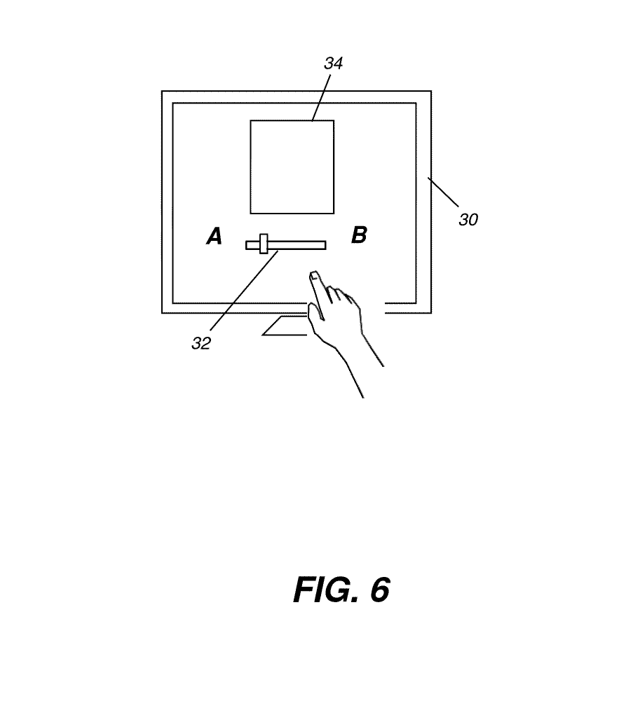

FIG. 6 is a plan view that shows an operator display console 30 that allows entry of operator/viewer instructions to adjust how pre-set images/image data captured at an image acquisition apparatus are blended to generate multiple secondary images away from the image acquisition apparatus. In one embodiment according to the application, a viewer has the capability to adjust combining/synthesis or interactively adjust the combining between (or among multiple) two different image treatments (e.g., see image 14a, 14b in FIG. 2, see treatment A, treatment B in FIG. 6). A control 32, shown as a displayed sliding bar in the example of FIG. 6, allows the viewer to adjust blending for image display 34 between two different image treatments, shown here as A and B. In one embodiment, A can be a soft tissue image; B can be a bone image, however the exemplary embodiments are not intended to be so limited. Using a graphical user interface of this type, the operator can interactively enter an instruction with a slider bar, icon or other control, other visual display or mechanical control (e.g., rotating knob) or the like that adjusts the predominance or relative influence of either image treatment A or image treatment B and view displayed results (e.g., real-time or interactively) as image display 34. It can be appreciated that FIG. 5 shows one type of interface that can be used. Any number of alternate types of control 32 could be provided for adjusting between two different image treatments.

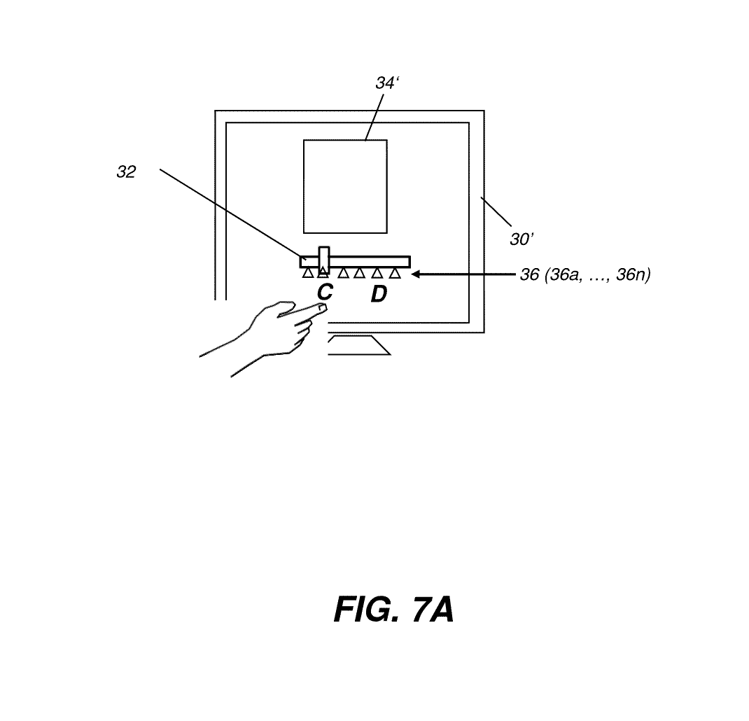

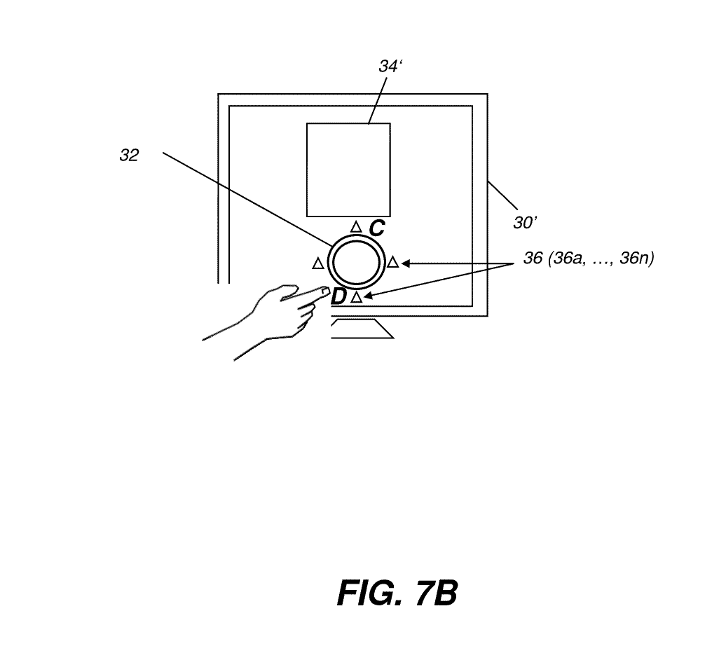

FIGS. 7A-7B are plan views that show a viewer display console 30′ that allows entry of viewer instructions to adjust how images are blended. As shown in FIGS. 7A-7B, the operator selectable image combining can use pre-determined “stops” 36a, . . . , 36n. In exemplary embodiments, exemplary pre-determined “stops” can be system generated, automatically generated based on patient characteristics, and/or user generated. Exemplary “stops” 36 can be visual, tactile, and/or audibly presented to the viewer. Selected ones of exemplary pre-determined “stops” 36a, . . . , 36n can represent a pre-determined first generated image C (e.g., bone image) or a pre-determined second generated image D (e.g., soft tissue image), which are formed from a combination (e.g., subtraction, noise reduced weighted subtraction, etc.) of at least two primary images, secondary images or combination thereof. As shown in FIGS. 7A-7B, changes in synthesis in the stored or displayed image display 34′ can be interactively modified by the viewer. In one embodiment, two primary raw images, the pre-determined first and second generated images (e.g., C, D) and at least one viewer generated image display 34′ can be stored at the operator display console 30′, the image management system 450, PACS or the like for subsequent display, transmission or printing.

In one exemplary embodiment, primary image data values from both the low energy image data 10a and high energy image data 10b are combined to generate a secondary image (e.g., soft tissue image 14a), which can be displayed or stored at the image acquisition apparatus, or transmitted (e.g., over a network) to a remote location (e.g. for display, storage or further transmission).

In another exemplary embodiment, the primary image data values from both a first image such as the low energy image data 10a and a second image such as the high energy image data 10b can be transmitted from the image acquisition apparatus to the remote location along with data parameter(s) identifying or controlling the combination of the primary image data values used to create the desired secondary image. At a remote location, the received data parameter can be used to control the formation of the desired secondary image as a designated combination of the first image and the second image. Thus, in one exemplary embodiment, primary image data can be transmitted (or stored) with prescribed data parameters and one or more corresponding companion images (e.g., gen rad, bone, soft tissue) can be remotely or subsequently generated as needed or selected. In one exemplary embodiment, companion images (e.g., viewer defined) can be defined and stored by a viewer (e.g., radiologist) at selected or preferred positions along the control 32.

In another exemplary embodiment, a displayed image 22 (e.g., secondary image) can be generated from the primary image data, low energy image data (10a) and high energy image data (10b), that is more quantitative in nature and that can be used to assist the end user or viewer in the characterization of different types of bodily tissue or materials. For example, the pixel values of the displayed image 22 can be constructed in such a way so as to identify the physical composition, e.g., blood, pus, serous fluid or some other type of anatomical tissue, of the corresponding anatomical region associated with the pixel location.

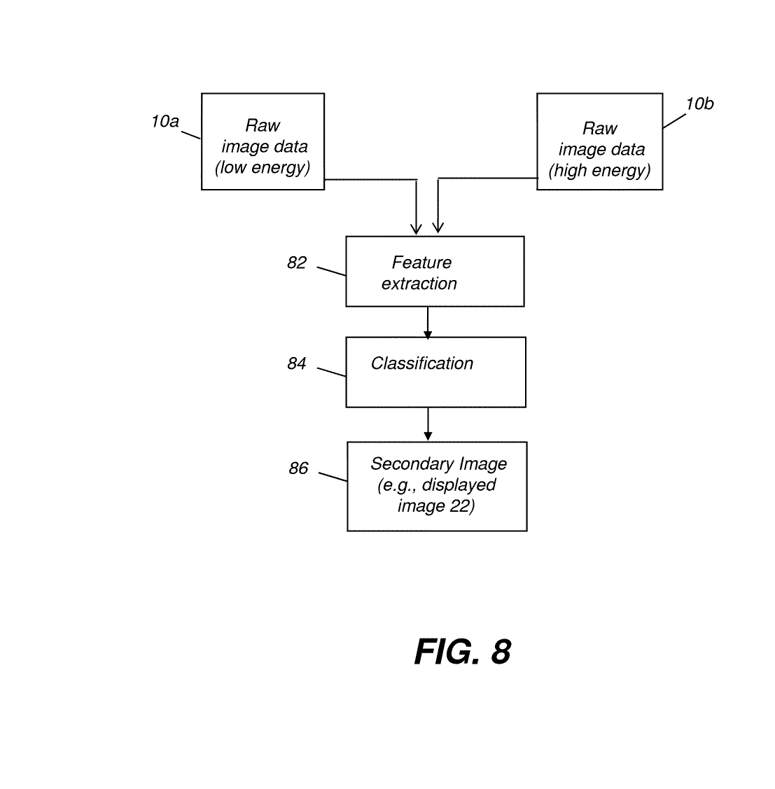

The logic flow diagram of FIG. 8 shows position/timing of a synthesis (e.g., blending) process for generating a displayed image 22 according to one exemplary embodiment of the application. In this embodiment, the pixel values of the displayed image 22 can be derived from a pixel classification scheme having two stages: a pixel feature extraction and a pixel classification. As shown in FIG. 8, examples of pixel features that can be extracted from each of the primary images include grayscale value, local texture, Gaussian derivative, and the like (operation block 82). Features can also be extracted from a combination of the primary images, such as the local texture and grayscale value of the soft-tissue image, for example. Next, pixel classification can use the features to determine the type of bodily tissue corresponding to the pixel location (operation block 84). Classification techniques such as artificial neural networks, support vector machines or random forests that are well known in the art can be used to perform the pixel classification. Resulting pixel values for the displayed image 22 (e.g., secondary image) can be set to discrete values based on an output or results of the pixel classification (operation block 86). The discrete value can be used to represent a color or grayscale level in the displayed image 22. Additionally in one embodiment, a secondary pixel level can be a prescribed or include an alpha component (e.g., transparency) that indicates or reflects the confidence in the pixel classification. In the specific case where there are only two classification options, e.g., blood or not blood, then the pixel values could be assigned a grayscale, or color, value that solely can indicate the confidence in the pixel classification. In the latter case, the resulting displayed image 22 can be a likelihood image of the distribution or concentration of blood throughout the image.

Multi-spectral or “color” x-ray imaging, enables information to be obtained about the material composition of a subject pixel. For example, two materials (e.g., a first material and a second material) have different coefficients of attenuation μ that vary with the level of radiation energy (e.g., exposure energy E). At a given exposure, a first material X attenuates a photon with an energy that corresponds to the first material X, and radiation impinging on a second material Y attenuates a photon with an energy that corresponds to the second material Y. This basic behavior in response to radiation also allows some measure of capability to differentiate tissue types. By way of example, different absorption characteristics (e.g., linear) allow differentiation between various types of tissue, fluid, and/or between bone types.

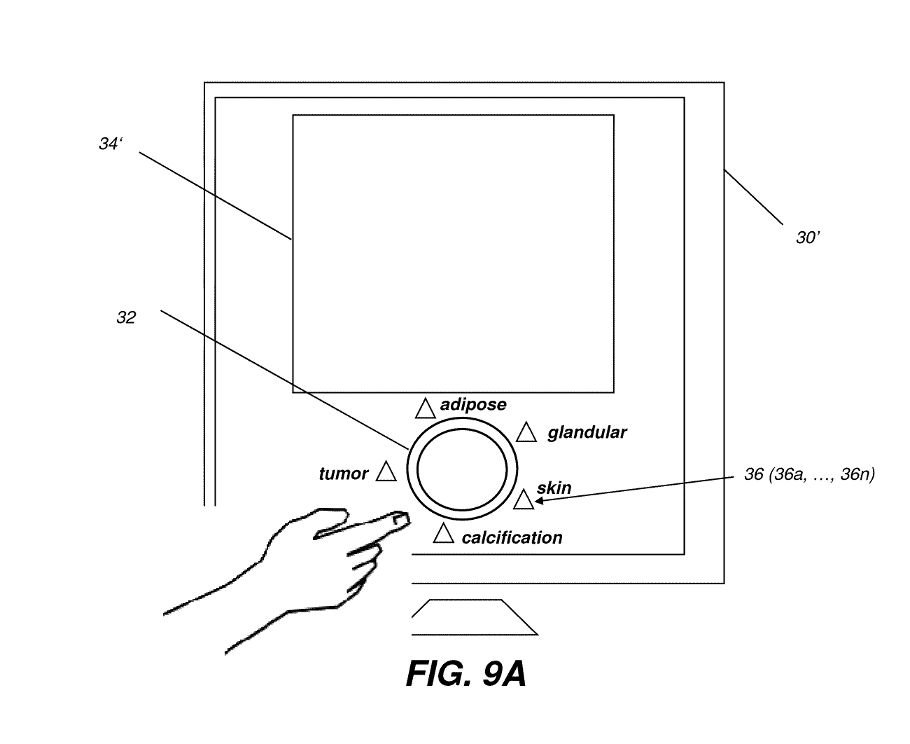

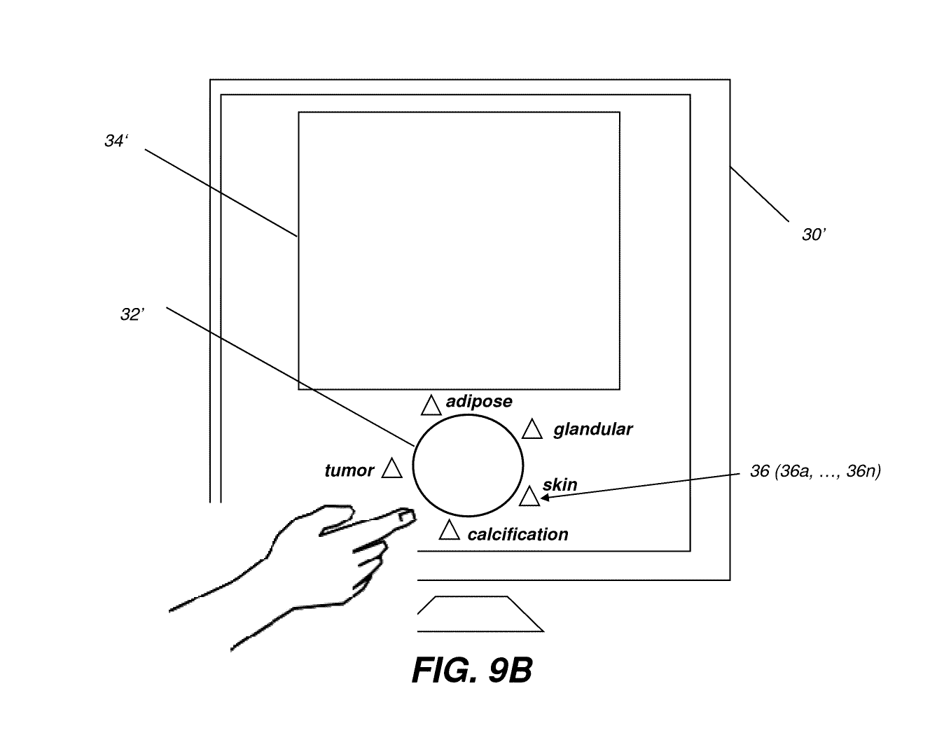

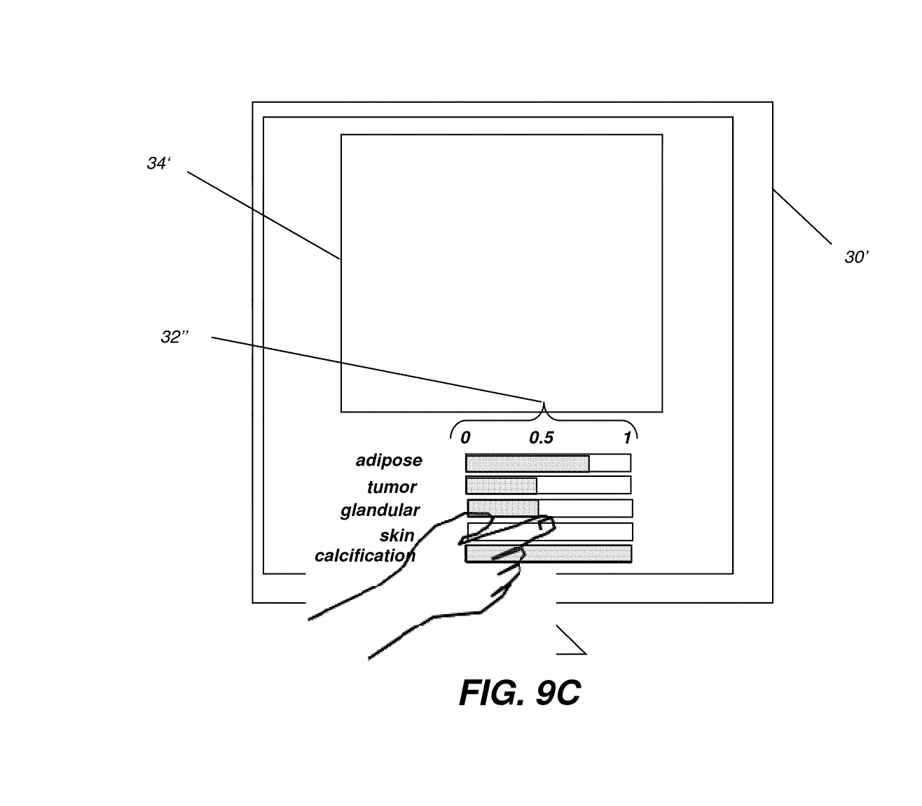

The radiation attenuation characteristic for a material, considered over a range of energy levels, can be fairly linear, with characteristic levels and slope for any material type. Since two points define a line and its slope, it can be useful to acquire two attenuation values, one at each of two different energy levels. For this capability to be realized, the X-ray attenuation coefficient for a material must be calculated, modeled, or empirically determined at two or more energies (e.g., polychromatic, monochromatic) for use with a radiographic 3D array of points of an object or 2D array of points in a projection image. Thus, to more accurately determine the material composition of a pixel (or voxel), two or more points of data are helpful. Exemplary embodiments of the application can provide a displayed image 22 (e.g., secondary image) that can be generated from first and second primary image data that is more quantitative in nature and that can be used to assist the viewer in characterization of different types of bodily tissue or materials in the displayed image 22. FIG. 9 is a diagram that shows an operator display console 30′ that allows entry of operator/viewer instructions to adjust how pre-set images/image data captured at an image acquisition apparatus can be synthesized among multiple displayed images 22 (e.g., secondary images) away from the image acquisition apparatus. As shown in FIGS. 9A-9C, a viewer has the capability to adjust synthesis or combining or interactively adjust the synthesis between (or among) different image processing treatments (e.g., preset, set at the radiographic image acquisition apparatus) for materials that can be common for a breast: adipose tissue, glandular tissue, skin, a calcification and/or a tumor. As shown in FIG. 9B, a trackball or touch-screen 32′ can be used to allow viewer controlled combinations (e.g., synthesis) of two or more materials for display (e.g., in different colors). Alternatively as shown in FIG. 9C, a GUI such as GUI 32″ can be used to selectively add and weight different materials (e.g., for display or storage).

Any of a number of types of blending algorithm could be used for combining images, using techniques well known in the image processing arts. According to an embodiment of the present invention, a sine/cosine relationship can be used, so that operator entry provides an angle whose sin and cos values are then used to weight the contribution of individual pixels to the final image.

Blending can be performed using primary or secondary images, including secondary images that have themselves been generated using secondary image data. Various types of weighting can be used for image data.

Embodiments according to the application have described as apparatus and/or methods. However, in another embodiment, the present invention comprises a computer program product for medical applications in accordance with the method described. In describing the present invention, it should be apparent that the computer program of the present invention can be utilized by any well-known computer system, such as a personal computer, such as a laptop or workstation or a microprocessor or other dedicated processor or programmable logic device, including networked computers or devices. However, many other types of computer systems can be used to execute the computer program of the present invention.

Consistent with an embodiment of the present invention, a computer executes a program with stored instructions that perform on image data accessed from an electronic memory. The computer program for performing the method of the present invention may be stored in a computer readable storage medium. This medium may comprise, for example; magnetic storage media such as a magnetic disk (such as a hard drive) or magnetic tape or other portable type of magnetic disk; optical storage media such as an optical disc, optical tape, or machine readable bar code; solid state electronic storage devices such as random access memory (RAM), or read only memory (ROM); or any other physical device or medium employed to store a computer program. The computer program for performing the method of the present invention may also be stored on computer readable storage medium that is connected over a network. Those skilled in the art will readily recognize that the equivalent of such a computer program product may also be constructed in hardware.

It will be understood that the computer program product of the present invention may make use of various image manipulation algorithms and processes that are well known. It will be further understood that the computer program product embodiment of the present invention may embody algorithms and processes not specifically shown or described herein that are useful for implementation. Additional aspects of such algorithms and systems, and hardware and/or software for producing and otherwise processing the images or co-operating with the computer program product of the present invention, are not specifically shown or described herein and may be selected from such algorithms, systems, hardware, components and elements known in the art.

It should be noted that the term “memory”, equivalent to “computer-accessible memory” in the context of the present disclosure, can refer to any type of temporary or more enduring data storage workspace used for storing and operating upon image data and accessible to a computer system. The memory could be non-volatile, using, for example, a long-term storage medium such as magnetic or optical storage. Alternately, the memory could be of a more volatile nature, using an electronic circuit, such as random-access memory (RAM) that is used as a temporary buffer or workspace by a microprocessor or other control logic processor device. Display data, for example, is typically stored in a temporary storage buffer that is directly associated with a display device and is periodically refreshed as needed in order to provide displayed data. This temporary storage buffer can also be considered to be a memory, as the term is used in the present disclosure. Memory is also used as the data workspace for executing and storing intermediate and final results of calculations and other processing. Computer-accessible memory can be volatile, non-volatile, or a hybrid combination of volatile and non-volatile types. Computer-accessible memory of various types is provided on different components throughout the system for storing, processing, transferring, and displaying data, and for other functions.

While the invention has been illustrated with respect to one or more implementations, alterations and/or modifications can be made to the illustrated examples without departing from the spirit and scope of the appended claims. In addition, while a feature(s) of the invention can have been disclosed with respect to only one of several implementations/embodiments, such feature can be combined with one or more other features of other implementations/embodiments as can be desired and/or advantageous for any given or identifiable function. The term “at least one of is used to mean one or more of the listed items can be selected. The term “about” indicates that the value listed can be somewhat altered, as long as the alteration does not result in nonconformance of the process or structure to the illustrated embodiment. Finally, “exemplary” indicates the description is used as an example, rather than implying that it is an ideal. Other embodiments of the invention will be apparent to those skilled in the art from consideration of the specification and practice of the invention disclosed herein. It is intended that the specification and examples be considered as exemplary only. The scope of the invention is indicated by the appended claims, and all changes that come within the meaning and range of equivalents thereof are intended to be embraced therein.

What is claimed is:

1. A method for displaying radiographic image content, the method comprising:
obtaining image data for a first radiographic image of a patient;
obtaining image data for a second radiographic image of a patient;
combining the image data from the first and second images and displaying the result as a combined radiographic image;
recombining the image data from the first and second images according to a viewer instruction that conditions how the first and second images are recombined and re-displaying the result as the combined radiographic image.

2. The method of claim 1 wherein the first radiographic image is acquired from an exposure at a first energy level in an examination and the second radiographic image is acquired from an exposure at a second energy level in the examination, and where the first and second energy levels are unequal.

3. The method of claim 1 wherein the first and second radiographic images are acquired from a dual-energy exposure.

4. The method of claim 1 wherein the operator instruction is entered using an adjustable icon on a graphical user interface, adjustable control at the graphical user interface or an adjustable mechanical control at a viewer console.

5. The method of claim 1 wherein the first and second radiographic images are acquired from processing image data obtained from the same exposure.

6. The method of claim 1 wherein the first and second radiographic images are acquired from the same exposure using an energy resolving detector.

7. The method of claim 1 wherein the first and second radiographic images are acquired from processing image data obtained from the different exposures controlled by parameters set by a radiographic technician.

8. The method of claim 1 where the image data of the first radiographic images and the image data of the second radiographic image are assigned different colors.

9. The method of claim 8, where the image data of the first radiographic images and the image data of the second radiographic image are displayed as different colors in the re-displayed recombined radiographic image.

10. A method for displaying radiographic image content at an image management system, the method comprising:
providing the capability to receive image data for a first preset secondary radiographic image of a patient over a communication network;
providing the capability to receive image data for a second preset secondary radiographic image of the patient over the communication network;
providing the capability to display the first preset secondary radiographic image or the second preset secondary radiographic image at the image management system;
providing the capability to variably combine the image data from the first preset secondary radiographic image and the image data from the second preset secondary radiographic image into a combined secondary radiographic image according to a viewer instruction, the viewer instruction is configured to variably modify a first weight of the image data from the first preset secondary radiographic image to a second weight of the image data from the second preset secondary radiographic image in the combined secondary radiographic image.

11. The method of claim 10, further comprising providing the capability to display or store the combined secondary radiographic image, where the first weight and the second weight are independent of each other.

12. An apparatus for displaying radiographic image content, comprising:
means for receiving image data for a first radiographic image of a patient;
means for receiving image data for a second radiographic image of a patient;
means for combining the image data from the first and second images and displaying the result as a combined radiographic image; and
means for recombining the image data from the first and second images according to a viewer instruction that conditions how the first and second images are recombined and means for re-displaying the result as the combined radiographic image.
